(19) United States
(12) Patent Application Publication
(10) Pub. No.: US 2018/0042447 A1
(43) Pub. Date: Feb. 15, 2018

(54) FILTER ASSEMBLY FOR A DISHWASHER APPLIANCE

(71) Applicant: Haier US Appliance Solutions, Inc., Wilmington, DE (US)

(72) Inventor: Joel Charles Boyer, Louisville, KY (US)

(21) Appl. No.: 15/234,010

(22) Filed: Aug. 11, 2016

(51) Int. Cl. A47L 15/42; B01D 29/86; B01D 29/64; F16K 1/14; B01D 29/01; B01D 35/147; F16K 17/02; C02F 1/00; B01D 29/58

(52) U.S. Cl. CPC A47L 15/4208; C02F 1/001; B01D 29/86; B01D 29/6476; B01D 29/58; B01D 29/01; B01D 35/1475; A47L 15/4204; F16K 17/02; F16K 1/14; C02F 2303/26; C02F 2307/12; B01D 2201/16; C02F 2201/005

(57) ABSTRACT

A filter assembly for filtering a wash fluid to be circulated by a circulation pump in a dishwasher appliance includes a filter member, housing, discharge chamber, and relief valve. The filter member defines a discharge opening, and includes an outer wall. The housing at least partially surrounds the filter member, and may include a peripheral wall. The housing defines an aperture that extends through the peripheral wall. The discharge chamber is defined between the outer wall and the peripheral wall. The relief valve includes a valve body surrounding the aperture on the peripheral wall, and a valve member disposed within a cavity defined by the valve body. The valve member is movable between a first position in which fluid communication between the discharge chamber and the cavity is restricted, and a second position in which fluid communication between the discharge chamber and the cavity is permitted.

### FIELD OF THE INVENTION

The present subject matter relates generally to dishwasher appliances and more particularly to filter assemblies for dishwasher appliances.

### BACKGROUND OF THE INVENTION

During wash and rinse cycles, dishwasher appliances generally circulate a fluid through a wash chamber over articles, such as pots, pans, silverware, etc. The fluid can be, e.g., various combinations of water and detergent during the wash cycle, or water (which may include additives) during the rinse cycle. Typically, the fluid is circulated during a given cycle using a pump. Fluid is collected at or near the bottom of the wash chamber and pumped back into the wash chamber through, e.g., nozzles in spray arms and other openings that direct the fluid against the articles to be cleaned or rinsed.

Depending upon the level of soil on the articles, fluids used during wash and rise cycles can become contaminated with soils in the form of debris or particles that are carried with the fluid. In order to protect the pump and recirculate the fluid through the wash chamber, it is beneficial to filter the fluid so that relatively clean fluid is applied to the articles in the wash chamber and soils are removed or reduced from the fluid supplied to the pump.

Accordingly, dishwasher appliances are generally provided with a filter assembly to trap at least certain of the soils carried with the wash fluid. Such filter assemblies generally include a coarse filter and a fine filter in a series flow configuration. For example, during a wash cycle a portion of the recirculated wash fluid progressively flows through filters that have smaller and smaller holes. Additionally, blades may be provided adjacent the filters to generally unclog soil from the filters and guide the soil towards discharge areas. It is generally desirable for these blades to be in close proximity to respective filters to facilitate such cleaning.

While such filter assemblies provide advantages with regard to filtering, improvements could be made with respect to the discharge area. For example, filter assemblies are oriented such that a pocket of air collects within the discharge area. As such, the pocket of air is ingested by a drain pump when a drain cycle is initiated to remove filtered soil and wash fluid from discharge area. This is undesirable, because the pocket of air promotes cavitation to occur within the pump and increases the run time of the pump.

Accordingly, improved filter assemblies are desired. In particular, filter assemblies which remove the pocket of air from the discharge chamber and prevent cavitation within the drain pump.

### BRIEF DESCRIPTION OF THE INVENTION

Aspects and advantages of the invention will be set forth in part in the following description, or may be apparent from the description, or may be learned through practice of the invention.

In a first exemplary embodiment, a filter assembly for filtering a wash fluid to be circulated by a circulation pump in a dishwasher appliance is provided. The filter assembly defines an axial direction and a radial direction that is orthogonal to the axial direction. Further, the filter assembly includes a filter member, housing, discharge chamber, and relief valve. The filter member may define a discharge opening, and may include a filter panel and outer wall. The outer wall may extend around a perimeter of the filter panel. The housing may at least partially surround the filter member, and may include a peripheral wall. Further, the housing may define an aperture that extends through the peripheral wall. The discharge chamber may be defined between the outer wall of the filter member and the peripheral wall. Additionally, the discharge chamber may be in fluid communication with the filter member through the discharge opening. The relief valve may include a valve body and a valve member. The valve body may surround the aperture formed on the peripheral wall, and may define a cavity that extends from the peripheral wall along the radial direction. The valve member may be disposed within the cavity, and may be movable along the radial direction between a first position and a second position. When the valve member is in the first position, fluid communication between the discharge chamber and the cavity may be restricted. In contrast, fluid communication between the discharge chamber and the cavity may be permitted when the valve member is in the second position.

In a second exemplary embodiment, a dishwasher appliance is provided. The dishwasher appliance includes a tub, a sump, a circulation pump, and a filter assembly. The filter assembly defines an axial direction and a radial direction that is orthogonal to the axial direction. Further, the filter assembly includes a filter member, housing, discharge chamber, and relief valve. The filter member may define a discharge opening, and may include a filter panel and outer wall. The outer wall may extend around a perimeter of the filter panel. The housing may at least partially surround the filter member, and may include a peripheral wall. Further, the housing may define an aperture that extends through the peripheral wall. The discharge chamber may be defined between the outer wall of the filter member and the peripheral wall. Additionally, the discharge chamber may be in fluid communication with the filter member through the discharge opening. The relief valve may include a valve body and a valve member. The valve body may surround the aperture formed on the peripheral wall, and may define a cavity that extends from the peripheral wall along the radial direction. The valve member may be disposed within the cavity, and may be movable along the radial direction between a first position and a second position. When the valve member is in the first position, fluid communication between the discharge chamber and the cavity may be restricted. In contrast, fluid communication between the discharge chamber and the cavity may be permitted when the valve member is in the second position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance in accordance with an exemplary embodiment of the present disclosure;

FIG. 2 provides a side, sectional view of the exemplary dishwasher appliance of FIG. 1;

FIG. 3 provides a side, cross-sectional view of a sump and circulation pump in accordance with an exemplary embodiment of the present disclosure;

FIG. 4 provides a perspective cross-sectional view of a filter assembly in accordance with an exemplary embodiment of the present disclosure;

FIG. 5 provides a close up perspective view of a filter member of the exemplary filter assembly of FIG. 4;

FIG. 6 provides a top, sectional view of a filter assembly in accordance with an exemplary embodiment of the present disclosure;

FIG. 7 provides a cross-sectional view of a relief valve in accordance with an exemplary embodiment of the present disclosure;

FIG. 8 provides a cross-sectional view of a cavity formed by the relief valve of FIG. 7;

FIG. 9 provides a cross-sectional view of a cavity formed by the relief valve of FIG. 7;

FIG. 10 provides a cross-sectional view of an exemplary embodiment of a valve member in a first position;

FIG. 11 provides a cross-sectional view of an exemplary embodiment of a valve member in a first position;

FIG. 12 provides a cross-sectional view of an exemplary embodiment of a valve member in an intermediate third position;

FIG. 13 provides a cross-sectional view of an exemplary embodiment of a valve member in a second position;

FIG. 14 provides a cross-sectional view of an exemplary embodiment of a valve member in a second position; and

FIG. 15 provides a cross-sectional view of an exemplary embodiment of a valve member in a first position.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, “third”, “fourth”, etc. may be used interchangeably to distinguish one component from another and are not intended to signify location or importance of the individual components.

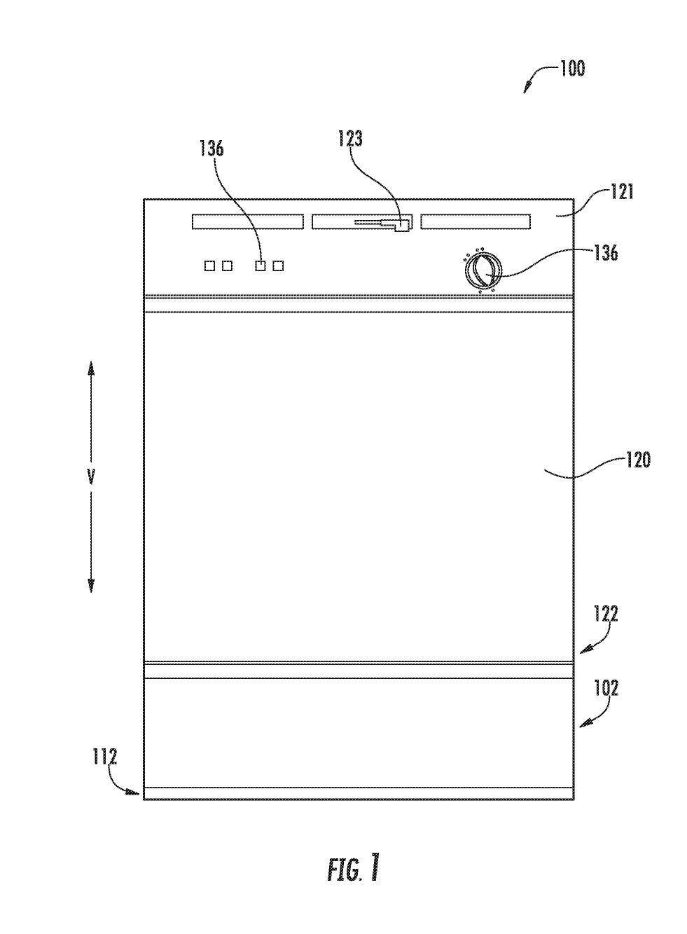

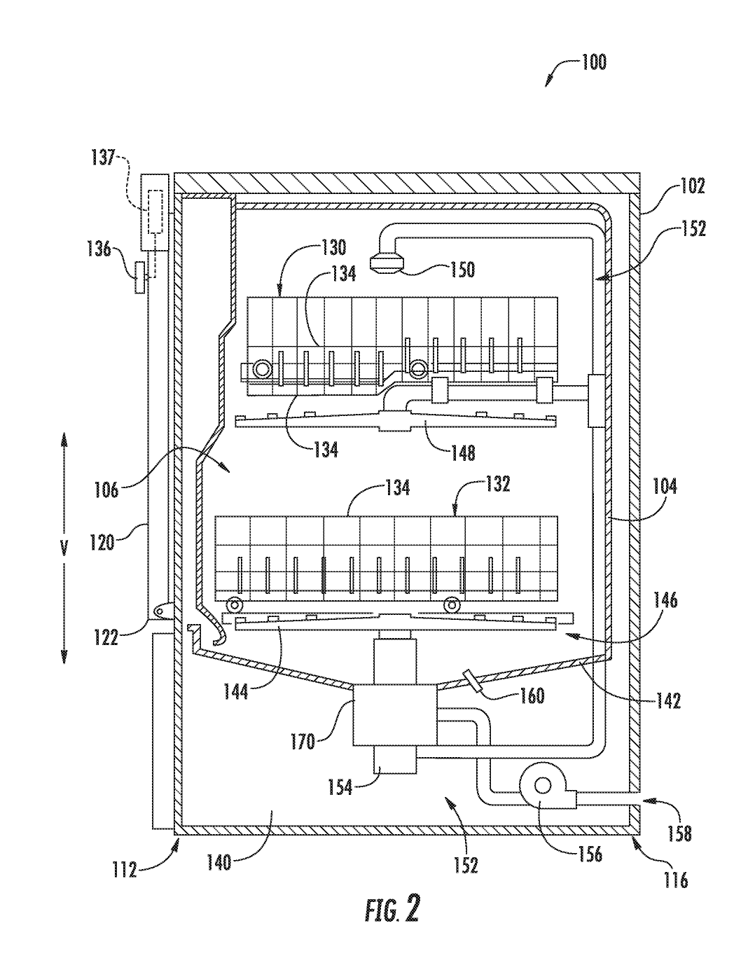

FIGS. 1 and 2 depict a dishwasher appliance 100 according to an exemplary embodiment of the present subject matter. FIG. 1 provides a front view of the exemplary dishwasher appliance 100, and FIG. 2 provides a side, sectional view of the exemplary dishwasher appliance 100.

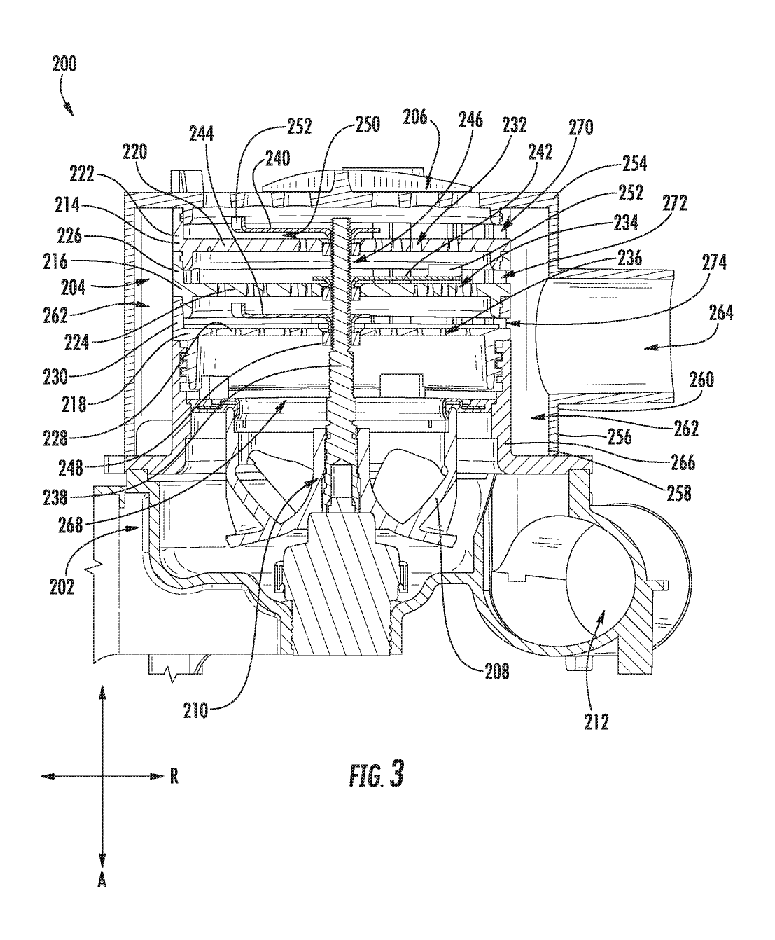

As shown, dishwasher appliance 100 defines a vertical direction V and includes a cabinet 102. Cabinet 102 has a tub 104 therein that defines a wash chamber 106. The tub 104 also defines a front opening (not shown). Dishwasher appliance 100 includes a door 120 hinged at a bottom 122 of door 120 for movement between a normally closed, vertical position (shown in FIGS. 1 and 2), wherein wash chamber 106 is sealed shut for washing operation, and a horizontal, open position for loading and unloading of articles from dishwasher appliance 100. A latch 123 is used to lock and unlock door 120 for access to wash chamber 106. Tub 104 also includes a sump assembly 170 shown schematically positioned adjacent a bottom portion 112 of tub 104 and configured for receipt of a liquid wash fluid (e.g., water, detergent, wash fluid, and/or any other suitable fluid) during operation of dishwasher appliance 100. More particularly, sump assembly 170 is shown attached to a bottom wall 142 of tub 104. As will be explained in greater detail below, the exemplary dishwasher appliance 100 may further include a filter assembly (not shown), such as a filter assembly 204 (see FIG. 3), disposed within sump assembly 170.

A spout 160 is positioned adjacent sump assembly 170 of dishwasher appliance 100. Spout 160 is configured for directing liquid into sump assembly 170. Spout 160 may receive liquid from, e.g., a water supply (not shown) or any other suitable source. In alternative embodiments, spout 160 may be positioned at any suitable location within dishwasher appliance 100, e.g, such that spout 160 directs liquid into tub 104. Spout 160 may include a valve (not shown) such that liquid may be selectively directed into tub 104. Thus, for example, during the cycles described below, spout 160 may selectively direct water and/or wash fluid into sump assembly 170 as required by the cycle of dishwasher appliance 100.

Rack assemblies 130 and 132 are slidably mounted within wash chamber 106. Each of the rack assemblies 130 and 132 is fabricated into lattice structures including a plurality of elongated members 134. Each rack of the rack assemblies 130 and 132 is adapted for movement between an extended loading position (not shown) in which the rack is substantially positioned outside the wash chamber 106, and a retracted position (shown in FIGS. 1 and 2) in which the rack is located inside the wash chamber 106. A silverware basket (not shown) may be removably attached to rack assembly 132 for placement of silverware, utensils, and the like, that are otherwise too small to be accommodated by the racks 130 and 132.

Dishwasher appliance 100 further includes a lower spray assembly 144 that is rotatably mounted within a lower region 146 of the wash chamber 106 and above sump assembly 170 so as to rotate in relatively close proximity to rack assembly 132. A mid-level spray assembly 148 is located in an upper region of the wash chamber 106 and may be located in close proximity to upper rack 130. Additionally, an upper spray assembly 150 may be located above the upper rack 130.

The lower and mid-level spray assemblies 144 and 148 and the upper spray assembly 150 are fed by a fluid circulation assembly 152 for circulating water and/or dishwasher fluid (collectively, “wash fluid”) in the tub 104. Fluid circulation assembly 152 may include a wash or circulation pump 154 and a cross-flow/drain pump 156 located in a machinery compartment 140 located below sump assembly 170 of the tub 104, as generally recognized in the art. Cross-flow/drain pump 156 is configured for urging wash fluid within sump assembly 170 out of tub 104 and dishwasher appliance 100 to a drain 158. Circulation pump 154 is configured to provide a flow of recirculated wash fluid to tub 104 and wash chamber 106. More particularly, circulation pump 154 is configured for supplying a flow of wash fluid from sump assembly 170 to spray assemblies 144, 148 and 150 via a plurality of circulation conduits (not labeled).

Each spray assembly 144 and 148 includes an arrangement of discharge ports or nozzles for directing wash fluid onto dishes or other articles located in rack assemblies 130 and 132. The arrangement of the discharge ports in spray assemblies 144 and 148 provides a rotational force by virtue of wash fluid flowing through the discharge ports. The resultant rotation of the lower spray assembly 144 provides coverage of dishes and other dishwasher contents with a spray of wash fluid.

Dishwasher appliance 100 is further equipped with a controller 137 (shown in phantom) to regulate operation of the dishwasher appliance 100. Controller 137 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 137 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 137 may be positioned in a variety of locations throughout dishwasher appliance 100. In the illustrated embodiment, controller 137 may be located within a control panel area 121 of door 120 as shown. In such an embodiment, input/output (“I/O”) signals may be routed between the control system and various operational components of dishwasher appliance 100 along wiring harnesses that may be routed through the bottom 122 of door 120. Typically, controller 137 includes a user interface 136 through which a user may select various operational features and modes and monitor progress of the dishwasher appliance 100. In one embodiment, user interface 136 may represent a general purpose I/O (“GPIO”) device or functional block. Additionally or alternatively, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

It should be appreciated that the subject matter disclosed herein is not limited to any particular style, model or configuration of dishwasher appliance, and that the embodiment depicted in FIGS. 1 and 2 is for illustrative purposes only. For example, instead of the racks 130 and 132 depicted in FIG. 1, dishwasher appliance 100 may be of a known configuration that utilizes drawers that pull out from the cabinet and are accessible from the top for loading and unloading of articles.

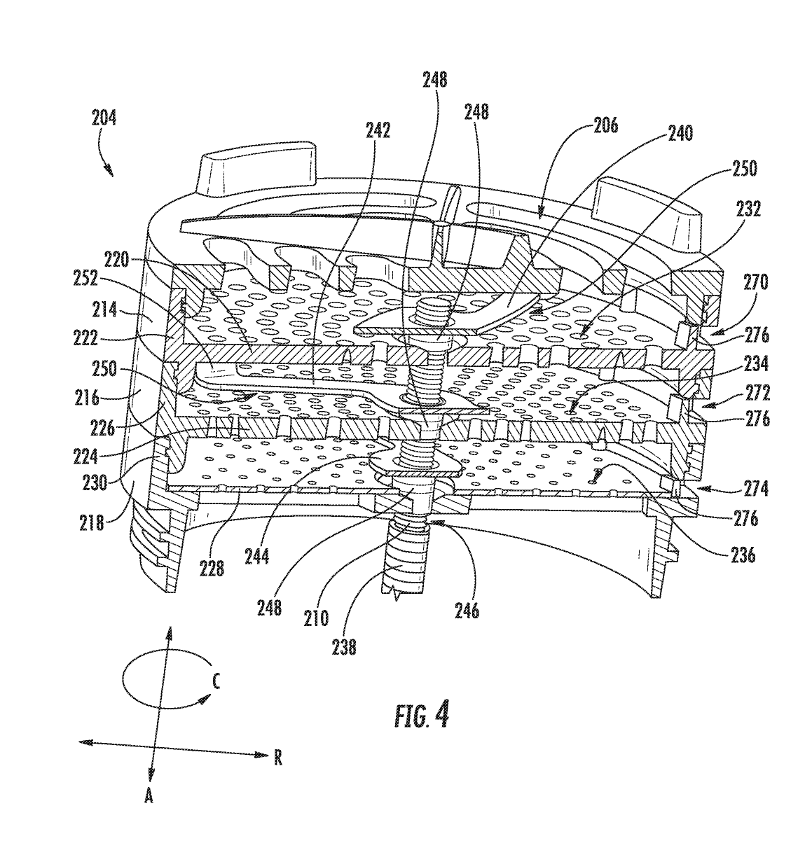

Reference will now be made to FIGS. 3 and 4. FIG. 3 provides a cross-sectional view of a portion of a sump 200 and circulation pump 202 in accordance with an exemplary embodiment of the present disclosure. Additionally, FIG. 4 provides a cross-sectional and perspective view of a filter assembly 204 in accordance with an exemplary embodiment of the present disclosure. In certain exemplary embodiments, sump 200 and circulation pump 202 may be configured as sump assembly 170 and circulation pump 154 in the exemplary dishwasher appliance 100 of FIGS. 1 and 2.

As is depicted, sump 200 generally includes a filter assembly 204 disposed within sump 200, and filter assembly 204 defines an axial direction A, a radial direction R, and a circumferential direction C. Circulation pump 202 is positioned adjacent to filter assembly 204 and in flow communication with filter assembly 204. Circulation pump 202 is configured to circulate or recirculate water/wash fluid from wash chamber 106 of tub 104. More particularly, circulation pump 202 is configured to urge a flow of wash fluid to be recirculated from wash chamber 106 of dishwasher appliance 100, through an inlet 206 in sump 200, and through filter assembly 204. Inlet 206 of sump 200 may be configured as an opening, e.g., in a bottom wall 142 of tub 104 of dishwashing appliance 100. From filter assembly 204, circulation pump 202 is configured to provide the flow of wash fluid to the tub 104 and wash chamber 106, or more particularly to provide the flow of wash fluid through one or more circulation conduits to one or more spray assemblies, such as spray assemblies 144, 148, 150 depicted in FIG. 2.

Circulation pump 202 generally includes an impeller 208, a shaft 210, and an electric motor (not shown). Shaft 210 extends generally along the axial direction A, and is rotatable in the circumferential direction C (i.e., about the axial direction A) by the motor. Impeller 208 is fixed to shaft 210 and rotated by shaft 210. Rotation of impeller 208 in the circumferential direction C by shaft 210 generates the flow of wash fluid to be recirculated through filter assembly 204 and into an outlet 212 of circulation pump 202. Outlet 212 of circulation pump 202 may be fluidly connected with the one or more circulation conduits to circulate or recirculate the wash fluid. For example, outlet 212 of circulation pump 202 may provide wash fluid to the one or more spray assemblies, such as spray assemblies 144, 148, 150 depicted in FIG. 2.

For the exemplary embodiment depicted, filter assembly 204 generally includes a plurality of stacked filter members configured in series flow. Accordingly, wash fluid to be recirculated flows sequentially through each of the plurality of filter members prior to being recirculated by circulation pump 202. With such a configuration, all wash fluid circulated or recirculated by circulation pump 202 is filtered by each of the plurality of filter members before reaching the circulation pump 202. Therefore, all wash fluid to be recirculated by circulation pump 202 may be filtered in a “single-pass” through filter assembly 204.

More particularly, for the embodiment depicted, the one or more filter members include a first filter member 214, a second filter member 216, and a third filter member 218. First filter member 214 defines a first filter panel 220 and a first outer wall 222 extending around a perimeter of first filter panel 220. Similarly, second filter member 216 defines a second filter panel 224 and a second outer wall 226 extending around a perimeter of the second filter panel 224, and the third filter member 218 defines a third filter panel 228 with a third outer wall 230 extending around a perimeter of the third filter panel 228.

Additionally, each of the one or more filter members are attached such that the respective filter panels are substantially parallel to one another. For example, the first filter panel 220 is substantially parallel to both second filter panel 224 and third filter panel 228. Moreover, for the embodiment depicted, first outer wall 222 is attached to second outer wall 226 using a screw-type connection, and second outer wall 226 is attached to third outer wall 230 also using a screw-type connection. However, in other embodiments, first, second, and third outer walls 222, 226, 230 may each be attached to one another in any other suitable manner.

Each of first, second, and third filter panels 220, 224, 228 are configured to prevent soils, such as food particles or other debris, greater than a predetermined size for the respective filter panel from passing therethrough. Additionally, each of the plurality of filter members 214, 216, 218 are configured to sequentially filter and remove smaller particles from the wash fluid to be recirculated. More particularly, as is depicted, first filter panel 220 defines a plurality of first filter openings 232, second filter panel 224 defines a plurality of second filter openings 234, and third filter panel 228 defines a plurality of third filter openings 236. First filter openings 232 are larger than second filter openings 234, and second filter openings 234 are larger than third filter openings 236. Accordingly, first filter member 214 may be referred to as a “coarse” filter, second filter member 216 may be referred to as a “medium” filter member, and third filter member 218 may be referred to as a “fine” filter member. Therefore, filter assembly 204 depicted may filter all particles larger than third filter openings 236 from the wash fluid to be recirculated in a single-pass through filter assembly 204.

For the embodiment depicted, each of first filter panel 220, second filter panel 224, and third filter panel 228 are configured as a wall defining first filter openings 232, second filter openings 234, and third filter openings 236, respectively. However, in other exemplary embodiments, first, second, and/or third filter panels 220, 224, 228 may instead be configured to include any other suitable filter medium, such as, e.g., a mesh filter.

Shaft 210 of circulation pump 202 extends through the plurality of filter members 214, 216, 218. More particularly, for the embodiment depicted, shaft 210 extends through third filter panel 228 of third filter member 218, through second filter panel 224 of second filter member 216, and through first filter panel 220 of first filter member 214. Filter assembly 204 depicted in FIGS. 3 and 4 further includes discharge blades attached to shaft 210 adjacent to the respective filter panels 220, 224, 228. More particularly, exemplary filter assembly 204 depicted includes a first discharge blade 240, a second discharge blade 242, and a third discharge blade 244. First discharge blade 240 is attached to shaft 210 and positioned adjacent to first filter panel 220; second discharge blade 242 is attached to shaft 210 and is positioned adjacent to the second filter panel 224; and third discharge blade 244 is attached to shaft 210 and positioned adjacent to third filter panel 228.

Each of the discharge blades 240, 242, 244 may be attached to shaft 210 in any suitable manner. For example, in the embodiment depicted, shaft 210 defines a plurality of circumferential threads 246 and the first, second and third discharge blades 240, 242, 244 are each screwed onto circumferential threads 246 of shaft 210. Notably, shaft 210 includes a plurality of setpoints 248 attached to shaft 210 adjacent to each of the blades 240, 242, 244 to ensure each the blades 240, 242, 244 defines a desired gap 250 along the axial direction A with the respective filter panel 220, 224, 228. For example, the discharge blades may be configured such that the blades define a gap 250 of between about five thousandths of an inch and about fifty thousandths of an inch.

It should be appreciated, however, that in other exemplary embodiments, each of the blades 240, 242, 244 may instead be set in position using any other suitable mechanism and may define any other suitable gap 250 with the respective filter panel 220, 224, 228. For example, in other exemplary embodiments, filter assembly 204 may instead include a washer between each of the blades 240, 242, 244 and the respective filter panel 220, 224, 228. Additionally, in other embodiments, filter assembly 204 may define a gap 250 of between about ten thousandths of an inch and about thirty thousandths of an inch, or between about fifteen thousandths of an inch and about twenty thousandths of an inch. Moreover, each of the blades 240, 242, 244 may define different gaps 250 with first, second, and third panels 220, 224, 228, respectively. It should also be appreciated, that as used herein, terms of approximation, such as “approximately” and “about,” refer to being within a ten percent margin of error.

Each of the exemplary blades 240, 242, 244 are configured to rotate in the circumferential direction C with shaft 210, and may serve the function of chopping particles greater than size of the respective filter openings 232, 234, 236. Further, as will be discussed below, blades 240, 242, 244 may also serve the functions of lifting particles off of the respective filter panels 220, 224, 228 and simultaneously moving particles outwardly along the radial direction R.

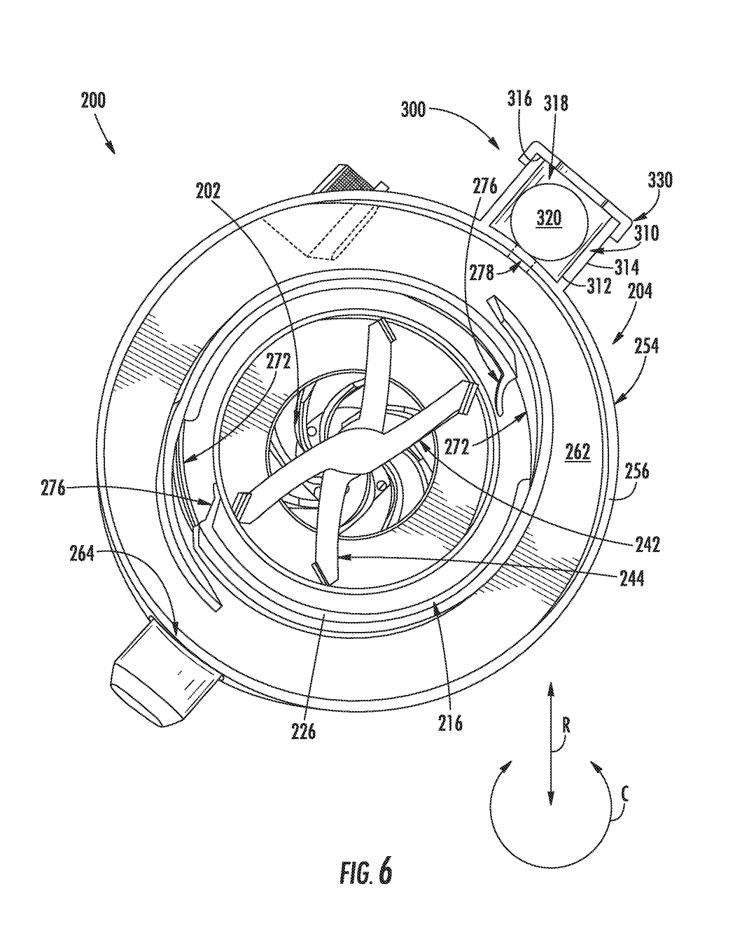

Referring particularly to FIG. 3 as well as to FIG. 6, sump 200 and filter assembly 204 thereof may include a housing 254 with a peripheral wall 256 extending around the one or more filter members. Peripheral wall 256 includes inner and outer surfaces 258, 260 and circumferentially surrounds the filter members 214, 216, 218. More particularly, inner surface 258 of peripheral wall 256 extends around first, second and third filter members 214, 216, 218, and defines a discharge chamber 262 with first, second, and third filter members 214, 216, 218. More particularly, inner surface 258 of peripheral wall 256 defines discharge chamber 262 with outer walls 222, 226, 230 of the respective filter assemblies 214, 216, 218. Discharge chamber 262 is thus defined between the outer walls 222, 226, 230 and inner surface 258 of peripheral wall 256. Additionally, peripheral wall 256 defines an outlet 264. Outlet 264 is in fluid communication with a drain pump (not shown), such as drain pump 156 depicted in FIG. 2.

Filter members 214, 216, 218 attach to housing 254 below inlet 206 using a screw type connection. However, in other embodiments, the one or more filter members may attach to housing 254 in any other suitable manner, or alternatively at least one of the one or more filter members may be formed integrally with housing 254 of sump 200. In some embodiments, filter assembly 204 may include a transition member 266 attached to a filter member, or more particularly attached to third filter member 218. Transition member 266 makes a connection between the one or more filter members and impeller 208 of circulation pump 202. Accordingly, transition member 266 defines filter assembly outlet 268 whereby filtered wash fluid to be recirculated passes into circulation pump 202. Alternatively, one of the filter members, such as the third filter member 218, may connect directly to impeller 208 and define filter assembly outlet 268.

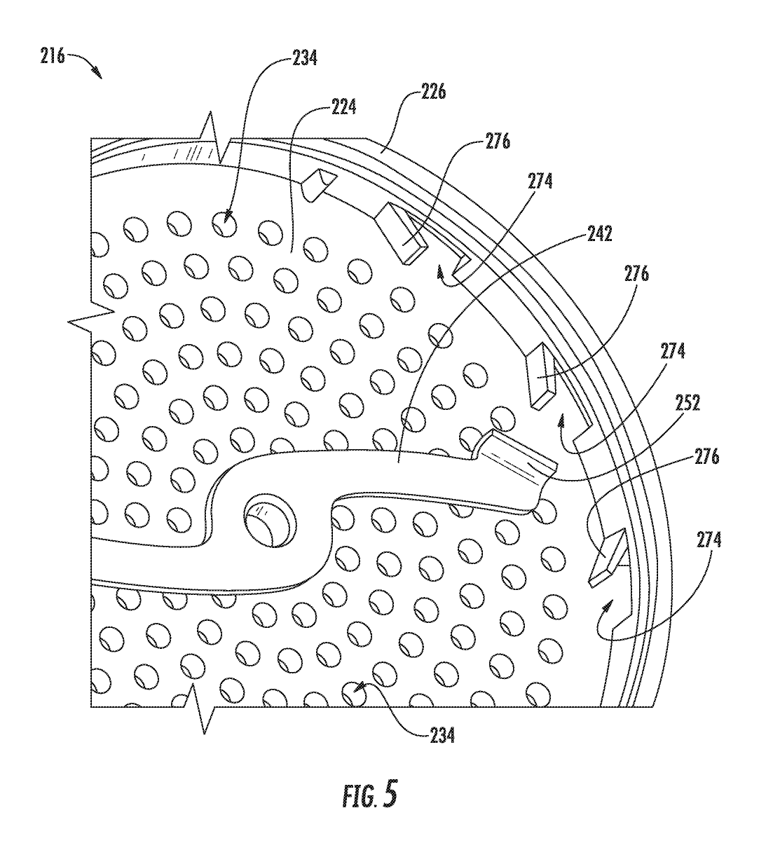

Referring now also to FIG. 5, a close-up perspective view of second filter member 216 is provided. Outer walls 222, 226, 230 of each of the respective filter members 214, 216, 218 define one or more discharge openings that allow for soils to pass from a respective filter panel 220, 224, 228 to discharge chamber 262. For example, first outer wall 222 of first filter member 214 defines one or more first discharge openings 270; second outer wall 226 of the second filter member 216 defines one or more second discharge openings 272; and third outer wall 230 of third filter member 218 defines one or more third discharge openings 274. For the embodiment depicted, each filter member 214, 216, 218 further includes guide members 276 slanting inwardly along the radial direction R from the respective outer walls 222, 226, 230 adjacent to each of the respective discharge openings 270, 272, 274. More particularly, the guide members 276 slant towards the discharge openings 270, 272, 274 to guide particles through the discharge openings 270, 272, 274 into the discharge chamber 262. As may be more clearly seen in FIG. 5, the guide members 276 each define an angle with regard to the radial direction R. The angle of guide members 276 may be between about ninety degrees and about one hundred and eighty degrees, such as between about one hundred and five degrees and about one hundred and sixty-five degrees, such as between about one hundred and twenty degrees and about one hundred and fifty degrees, such as about one hundred and thirty-five degrees.

During operation of dishwasher appliance 100, or more particularly, during a wash or rinse cycle of dishwasher appliance 100, wash fluid may enter filter assembly 204 through inlet 206 and travel to first filter member 214. The wash fluid may be filtered by first filter panel 220 wherein soils larger than the first filter openings 232 are prevented from flowing therethrough to second filter member 216. At the same time wash fluid and soils smaller than first filter openings 232 may pass therethrough to second filter member 216. The wash fluid may then be filtered by second filter panel 224, wherein soils larger than second filter openings 234 are prevented from flowing therethrough to third filter member 218, while wash fluid and soils smaller than second filter openings 234 may pass therethrough to third filter member 218. The wash fluid may then be filtered by third filter panel 228, wherein soils larger than third filter openings 236 are prevented from flowing to circulation pump 202, while the wash fluid to be recirculated may pass therethrough to circulation pump 202 and be recirculated into tub 104 and wash chamber 106.

Moreover, during operation of the exemplary dishwasher appliance 100, or more particularly during a wash or rinse cycle of the exemplary dishwasher appliance 100, the motor of circulation pump 202 may rotate shaft 210, which in turn may rotate impeller 208 and each of first, second, and third discharge blades 240, 242, 244. The rotation of first, second, and third discharge blades 240, 242, 244 by shaft 210 may allow discharge blades 240, 242, 244 to chop soils greater than the respective first, second, and third filter openings 232, 234, 236 and/or move soils outward along the radial direction R through the respective discharge openings 270, 272, 274. For example, first discharge blade 240 may move soils larger than first filter openings 232 outward along the radial direction R through the one or more first discharge openings 270 and into the discharge chamber 262. Similarly, second discharge blade 242 may move soils larger than second filter openings 234 outward along the radial direction R through the one or more second discharge openings 272 and into discharge chamber 262. Further, third discharge blade 244 may move soils larger than third filter openings 236 outward along the radial direction R through the one or more third discharge openings 274 and into discharge chamber 262.

Referring now to FIG. 6, as illustrated, discharge chamber 262 in exemplary embodiments is a circumferentially continuous discharge chamber 262. In other words, discharge chamber 262 is continuous generally annularly and along the circumferential direction, such that wash fluid in the chamber 262 can freely rotate in a generally continuous flow path along the circumferential direction, such as annularly within discharge chamber 262. Accordingly, particles that are removed from the filter members 214, 216, 218, such as from the panels 220, 224, 228 thereof, and traversed through the discharge openings 270, 272, 274 into the discharge chamber 262 may advantageously remain in the discharge chamber 262 until particles are drained from discharge chamber 262 via filter assembly outlet 268.

As discussed, particles (and wash fluid) may flow through the discharge openings 270, 272, 274 into the circumferentially continuous discharge chamber 262. Further, as discussed, guide members 276 may guide particles through the discharge openings 270, 272, 274 into the discharge chamber 262. The guide members 276 and openings 270, 272, 274 of each filter member 214, 216, 218 may be spaced apart from each other along the circumferential direction, as illustrated. For example, in some exemplary embodiments, each filter member 214, 216, 218 may include two openings 270, 272, 274 and two associated guide members 276. The two openings 270, 272, 274 and two associated guide members 276 of each filter member 214, 216, 218 may, for example, be spaced between 170 and 190 degrees apart, such as between 175 and 185 degrees apart, such as approximately 180 degrees apart along the circumferential direction. Alternatively, one, three, four or more openings 270, 272, 274 and associated guide members 276 may be utilized. Further, discharge openings 270, 272, 274 and associated guide members 276 may have any suitable spacing along the circumferential direction.

The filtered soils along with some accompanying wash fluid may be stored in discharge chamber 264 until wash cycle is complete and a discharge cycle is activated. During a discharge cycle, the drain pump is activated and wash fluid is pulled through, e.g., discharge chamber 264 and outlet 266 into and through a drain pipe (not shown). The drain pipe may be fluidly connected with a drain or other plumbing configured to dispose of such wash fluid and filtered particles. Notably, in certain embodiments, an appropriate amount of continuous flow of wash fluid, generated by the respective blades 240, 242, 244, may flow with filtered soils into discharge chamber 264 and through outlet 266 during a wash and/or rinse cycle of dishwasher appliance 100. In such an embodiment, a length of the drain pipe of the exemplary dishwasher appliance 100 may be filled with filtered/discharged soils and wash fluid (i.e., wash fluid that will not be recirculated). Such a configuration may accommodate storage of the filtered/discharged soils and accompanying wash fluid during a wash and/or rinse cycle of the exemplary dishwasher appliance 100. Additionally, in certain embodiments, the drain pump 156 may be activated for a relatively short period of time during, e.g., a wash or rinse cycle, in order to provide drainage of the wash fluid and filtered/discharged soils prior to a drain cycle.

Still referring to FIG. 6, the housing 254 defines an aperture 278 extending therethrough. More specifically, the aperture 278 extends between the inner and outer surfaces 258, 260 of the peripheral wall 256 along radial direction R. Also, the filter assembly 204 includes a relief valve 300 comprising a valve body 310, a valve member 320, and a cap 330. The valve body 310 includes an interior surface 312 and an exterior surface 314 spaced apart from the interior surface 312 along the circumferential direction C. As shown, the interior and exterior surfaces 312, 314 extend from the housing 254, or more particularly the outer surface 260 of the peripheral wall 256, along the radial direction R. Further, the interior surface 312 is spaced apart from the aperture 278 along the circumferential direction C. More specifically, the interior surface 312 surrounds the aperture 278 such that the valve body 310 defines a cavity 318 positioned over the aperture 278 along the radial direction R. The valve member 320 is disposed within the cavity 318, and the cap 330 is positioned on an end 316 of the valve body 310. It should be appreciated that the valve member 320 may define any suitable shape and may be comprised of any suitable material. For example, the valve member 320 may be sphere comprised of an elastomer material (e.g., rubber).

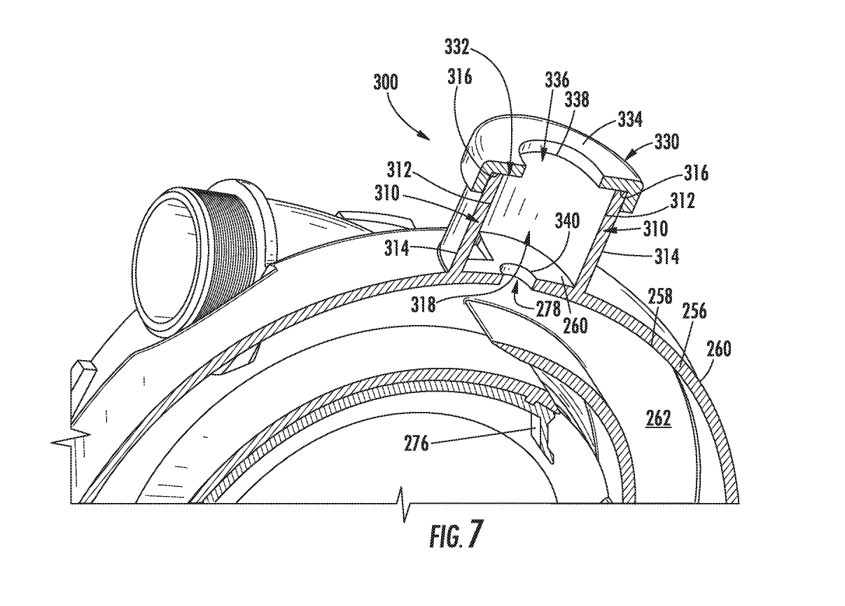

FIG. 7 provides a cross-sectional view of the relief valve 300 without the valve member 320. The cap 330 includes a bottom 332 and a top 334. As shown, the bottom 332 is positioned on the end 316 of the valve body 310. The cap 330 defines an opening 336 that extends therethrough, and the cap 330 further includes an inside edge 338 that defines a perimeter of the opening 336. The outer surface 260 of the peripheral wall 256 includes an inside edge 340 that defines a perimeter of the aperture 278. As will be discussed below in more detail, the valve member 320 is movable within the cavity 318, and may contact the cap 330, or more particularly the inside edge 338 of the cap 330, to restrict fluid communication between the cavity 318 and the opening 336. Further, the valve member 320 may also contact the outer surface 260, or more particularly the inside edge 340 of the outer surface 260, to prohibit fluid communication between the discharge chamber 262 and the cavity 318.

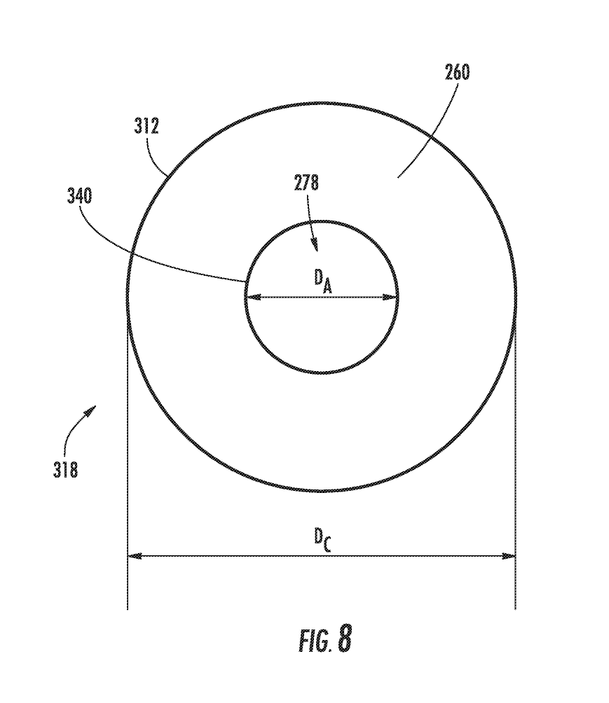

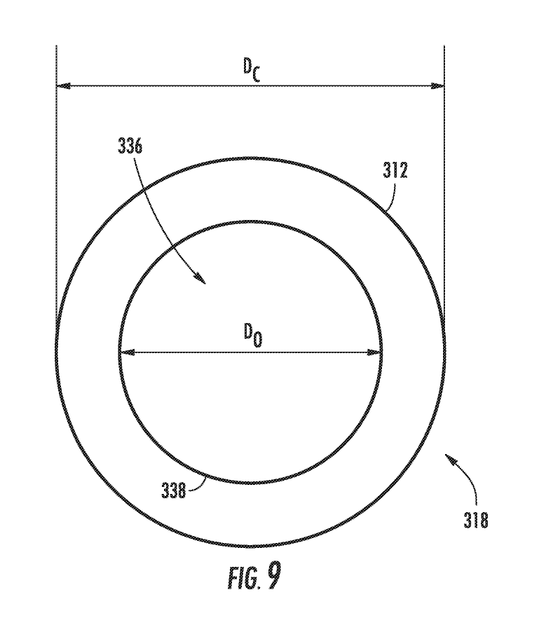

FIGS. 8 and 9 provide cross-sectional views of the cavity 318 formed by the interior surface 312 of the valve body 310. As shown, the cavity 318 defines a maximum diameter D_{C}, the aperture 278 defines a maximum diameter D_{A}, and the opening 336 defines a maximum diameter D_{O}. The maximum diameter D_{C} of the cavity 318 is greater than both D_{A} and D_{O} to contain the valve member 320 within the cavity 318. Further, as shown in FIGS. 8 and 9, the maximum diameter D_{O} of the opening 336 is different from the maximum diameter D_{A} of the aperture 278. More specifically, the maximum diameter D_{O} of the opening 336 is greater than the maximum diameter D_{A} of the aperture 278. However, it should be appreciated that, in other embodiments, the maximum diameter D_{O} of the opening 336 may be less than the maximum diameter D_{A} of the aperture 278. Further, in another embodiment, the maximum diameter D_{O} of the opening 336 may be equal to the maximum diameter D_{A} of the aperture 278.

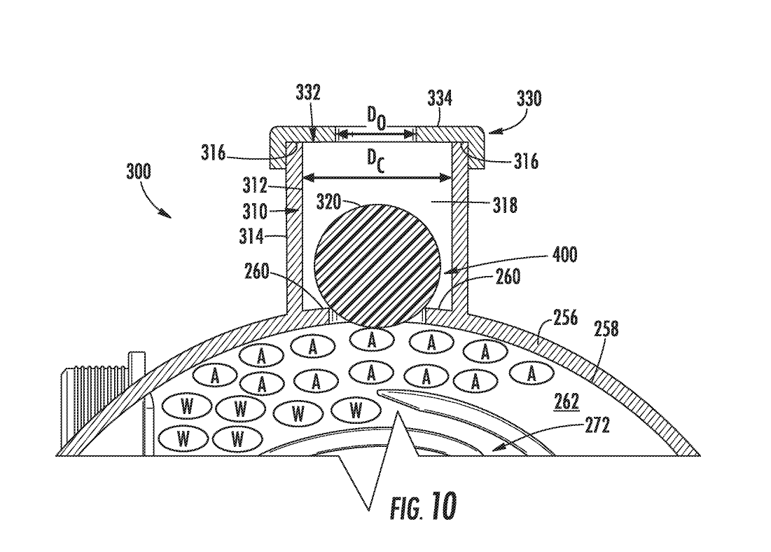

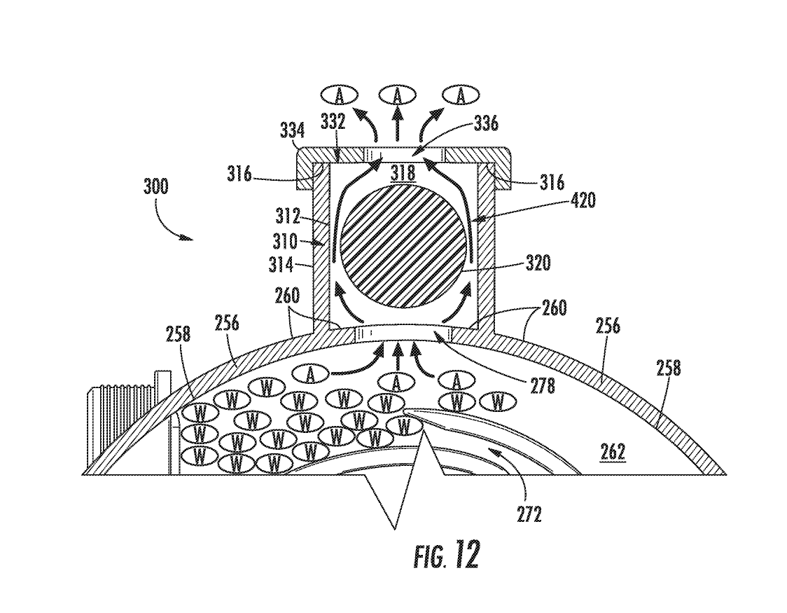

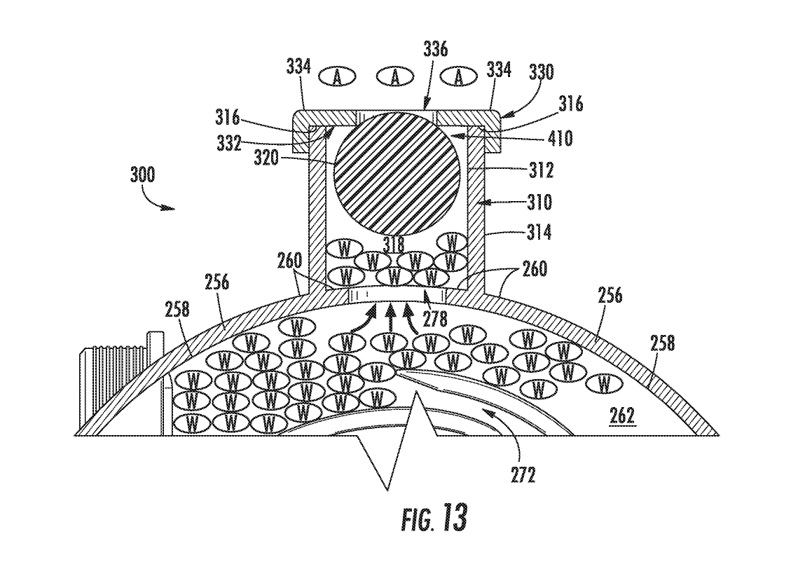

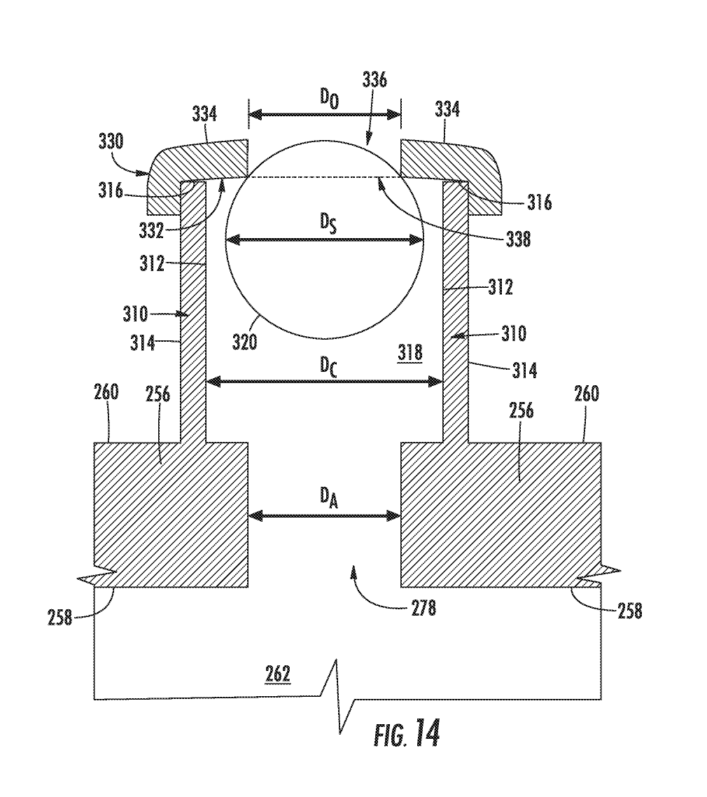

FIGS. 10-15 illustrate movement of the valve member 320 within the cavity 318. More specifically, FIGS. 10, 11 and 15 depict the valve member 320 in a first position 400, FIG. 12 depicts the valve member 320 in an intermediate third position 420, and FIGS. 13 and 14 depict the valve member in a second position 410. As will be discussed below in more detail, the valve member 320 moves between the first and second positions 400, 410 during a drain cycle to remove air A from the discharge chamber 262. More specifically, the valve member 320 removes the air A at the beginning of the drain cycle to reduce or eliminate the likelihood of cavitation within a drain pump (not shown), such as the drain pump 156 of FIG. 2. Further, removing the air A from the discharge chamber 262 improves the efficiency of the drain pump 156, which translates into energy savings of the dishwasher appliance 100.

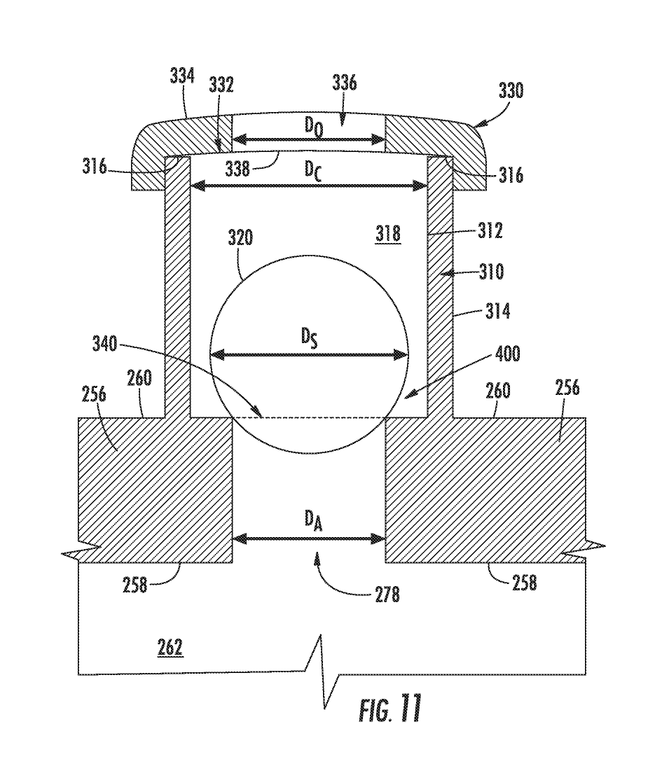

As shown in FIG. 11, the valve member 320 defines a maximum diameter D_{S} that is less than the maximum diameter D_{C} of the cavity 318. In addition, the maximum diameter D_{S} of the valve member 320 is greater than both the maximum diameter D_{A} of the aperture 278 and the maximum diameter D_{O} of the opening 336. As such, movement of the valve member 320 is confined between the aperture 278 and the opening 336, or more particularly the first and second positions 400, 410.

In FIG. 11, the valve member 320 is shown in the first position 400. In the first position 400, a portion of the valve member 320 extends into the aperture 278. More specifically, the valve member 320 contacts, or seals against, the inside edge 340 of the outer surface 260 to restrict fluid communication between the discharge chamber 262 and the cavity 318. As such, when the valve member 320 is in the first position 400, air A and water W in the discharge chamber 262 cannot enter the cavity 318 through the aperture 278.

In FIG. 12, the valve member 320 is shown in the intermediate third position 420. In the intermediate third position 420, the valve member 320 is spaced apart from both the inside edge 340 of the aperture 278 and the inside edge 338 of the opening 336. As such, air A from the discharge chamber 262 may enter the cavity 318 through the aperture 278 and subsequently exit the cavity 318 through the opening 336.

When the valve member 320 is in the intermediate third position 420, it should be appreciated that water W from the discharge chamber 262 may also enter the cavity 318. However, unlike the air A, the water W does not subsequently exit the cavity 318 through the opening. Instead, a drain pump (not shown), such as the drain pump 156 of FIG. 2, draws water W back into discharge chamber 262 through the aperture 278 and subsequently removes water W from the discharge chamber 262 via the drain 158.

In FIGS. 13 and 14, the valve member 420 is shown in the second position 410. In the second position 410, a portion of the valve member 320 extends into the opening 336. More specifically, the valve member 320 contacts, or seals against, the inside edge 338 of the cap 330 to restrict fluid communication between the cavity 318 and the opening 336. Accordingly, when the valve member 320 is in the second position 410, water W cannot exit the cavity 318 through the opening 336. As mentioned above, fluid communication between the aperture 278 and the cavity 318 occurs while the valve member 320 is in the second position 410. However, the drain pump removes the fluid (that is, water W) from the cavity 318 via the aperture 278. More specifically, the drain pump 156 draws the water W back into the discharge chamber 262 and subsequently removes the water W from the discharge chamber 262 via a drain conduit (not shown) connected to the drain 158.

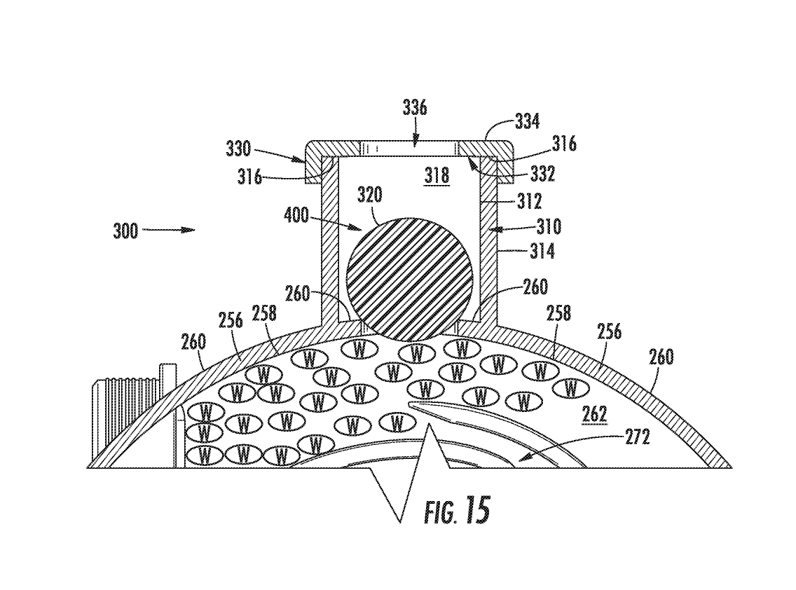

Referring now to FIG. 15, the valve member 320 moves from the second position 410 to the first position 400 once the drain pump has removed the water W from the cavity 318. More specifically, the valve member 320 contacts the inside edge 340 of the outer surface 260. As such, the valve member 320 restricts the flow of water W from the discharge chamber 262 to the cavity 318 via the aperture 278.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A filter assembly for filtering a wash fluid to be circulated by a circulation pump in a dishwasher appliance, the filter assembly defining an axial direction and a radial direction orthogonal to the axial direction, the filter assembly comprising:
a filter member defining a discharge opening, the filter member including a filter panel and an outer wall extending around a perimeter of the filter panel;
a housing at least partially surrounding the filter member, the housing including a peripheral wall and defining an aperture that extends through the peripheral wall;
a discharge chamber defined between the outer wall and the peripheral wall, the discharge chamber in fluid communication with the filter member through the discharge opening; and
a relief valve comprising:
a valve body surrounding the aperture formed on the peripheral wall, the valve body defining a cavity that extends from the peripheral wall along the radial direction; and
a valve member disposed within the cavity, the valve member movable along the radial direction between a first position and a second position,
wherein fluid communication between the discharge chamber and the cavity is restricted when the valve member is in the first position, and
wherein fluid communication between the discharge chamber and the cavity is permitted when the valve member is in the second position.

2. The filter assembly of claim 1, wherein the relief valve includes a cap positioned on the valve body, the cap defining an opening.

3. The filter assembly of claim 2, wherein the cap is integrally formed with the valve body.

4. The filter assembly of claim 2, wherein the valve member is movable to an intermediate third position that is between the first position and the second position along the radial direction, and wherein fluid communication between the cavity and the opening is permitted when the valve member is in the intermediate third position.

5. The filter assembly of claim 2, wherein the valve member contacts an inside edge of the cap while the valve member is in the second position.

6. The filter assembly of claim 5, wherein the inside edge defines a perimeter of the opening.

7. The filter assembly of claim 1, wherein a portion of the valve member extends into the aperture when the valve member is in the first position.

8. The filter assembly of claim 1, further comprising a discharge blade attached to a shaft that extends through the filter member and is rotatable about the axial direction, the discharge blade positioned adjacent to the filter panel.

9. The filter assembly of claim 1, wherein the valve member comprises an elastomer material.

10. A dishwasher appliance defining a vertical direction, the dishwasher appliance comprising:
a tub defining a wash chamber;
a sump positioned at a bottom portion of the tub along the vertical direction;
a circulation pump for circulating a wash fluid in the sump to the wash chamber; and
a filter assembly disposed within the sump and in flow communication with the circulation pump, the filter assembly defining an axial direction and a radial direction orthogonal to the axial direction, the filter assembly comprising:
a filter member defining a discharge opening, the filter member including a filter panel and an outer wall extending around a perimeter of the filter panel;
a housing for the filter member, the housing including a peripheral wall and defining an aperture that extends through the peripheral wall;
a discharge chamber defined between the outer wall and the peripheral wall, the discharge chamber in fluid communication with the filter member through the discharge opening; and
a relief valve comprising:
a valve body surrounding the aperture formed on the peripheral wall, the valve body defining a cavity that extends from the peripheral wall along the radial direction; and
a valve member disposed within the cavity, the valve member movable along the radial direction between a first position and a second position,
wherein fluid communication between the discharge chamber and the cavity is restricted when the valve member is in the first position, and
wherein fluid communication between the discharge chamber and the cavity is permitted when the valve member is in the second position.

11. The dishwasher appliance of claim 10, wherein the relief valve includes a cap positioned on the valve body, the cap defining an opening

12. The dishwasher appliance of claim 11, wherein the cap is integrally formed with the valve body.

13. The dishwasher appliance of claim 11, wherein the valve member is movable to an intermediate third position that is between the first position and the second position along the radial direction, and wherein fluid communication between the cavity and the opening is permitted when the valve member is in the intermediate third position.

14. The dishwasher appliance of claim 11, wherein the valve member contacts an inside edge of the cap while the valve member is in the second position.

15. The dishwasher appliance of claim 14, wherein the inside edge defines a perimeter of the opening.

16. The dishwasher appliance of claim 10, wherein a cross-sectional area of the valve member is greater than a cross-sectional area of the aperture formed on the peripheral wall of the housing.

17. The dishwasher appliance of claim 10, wherein a portion of the valve member extends into the aperture when the valve member is in the first position.

18. The dishwasher appliance of claim 17, wherein the valve member defines a maximum diameter and the cavity defines a maximum diameter, and wherein the maximum diameter defined by the cavity is greater than the maximum diameter defined by the valve member.

19. The dishwasher appliance of claim 10, further comprising a discharge blade attached to a shaft that extends through the filter member and is rotatable about the axial direction, the discharge blade positioned adjacent to the filter panel.

20. The dishwasher appliance of claim 10, wherein the valve member comprises an elastomer material.
